(19) United States
(12) Patent Application Publication
(10) Pub. No.: US 2026/0153033 A1
(43) Pub. Date: Jun. 4, 2026

(54) TURBO ENGINE INCLUDING A SYSTEM TO CONTROL PITCH OF A PROPELLER BLADE

(71) Applicants: General Electric Company, Evendale, OH (US); General Electric Company Polska sp. z o.o., Warsaw (PL)

(72) Inventors: Pei-Hsin Kuo, Alplaus, NY (US); Krzysztof Jedlinski, Otwock (PL); Mariusz Pawel Staszak, Warszawa (PL); Bugra H. Ertas, Niskayuna, NY (US); Keith A. Miedema, Fairfield, OH (US); Ahmet Dindar, Ballston Spa, NY (US); Kedar S. Vaidya, Albany, NY (US); David Justin Brady, Rockport, MA (US)

(21) Appl. No.: 18/958,225

(22) Filed: Nov. 25, 2024

(30) Foreign Application Priority Data
Aug. 9, 2024 (PL) P.449490

(51) Int. Cl. F01D 7/00; F15B 1/04

(52) U.S. Cl. CPC F01D 7/00; F15B 1/04; F05D 2260/79

(57) ABSTRACT

An example turbo engine includes a propeller including a blade, the blade rotatable about a centerline axis to change a pitch of the blade; and a blade pitch control system including: a fan pitch actuation system coupled to the blade, the fan pitch actuation system moveable to rotate the blade from a first pitch angle to a second pitch angle based on an amount of hydraulic fluid pumped into the fan pitch actuation system; an accumulator to store the hydraulic fluid; and a valve coupled to an output of the accumulator and an input of the fan pitch actuation system, the valve to automatically provide the hydraulic fluid from the accumulator to the fan pitch actuation system based on a control signal.

### RELATED APPLICATIONS

This patent claims the benefit of Polish Patent Application No. P.449490, which was filed on Aug. 9, 2024. Polish Patent Application No. P.449490 is hereby incorporated herein by reference in its entirety. Priority to Polish Patent Application No. P.449490 is hereby claimed.

### FIELD OF THE DISCLOSURE

The present disclosure relates generally to a turbo engine and, more particularly, to a turbo engine including a system to control pitch of a propeller blade.

### BACKGROUND

Turbo engines (e.g., turbofan engines, turboprop engines, etc.), such as those used on aircraft, generally include a propeller/fan and a gas turbine engine to drive the propeller/fan to produce thrust. In some configurations, the propeller/fan has variable pitch blades. As such, the pitch of the blades can be changed during different phases of operation.

### BRIEF DESCRIPTION OF THE DRAWINGS

A full and enabling disclosure of the presently described technology, including the best mode thereof, directed to one of ordinary skill in the art, is set forth in the specification, which makes reference to the appended Figs., in which:

FIG. 1 is a schematic cross-sectional view of an example turboprop engine in which examples disclosed herein can be implemented.

FIG. 2 includes side views of blades of the propeller of the turboprop engine of FIG. 1 in three different pitch angles.

FIG. 3 illustrates a fan pitch actuation system to implement the automatic blade pitch control of FIG. 1.

FIG. 4 illustrates an alternative fan pitch actuation system to implement the automatic blade pitch control of FIG. 1.

FIG. 5 illustrates an alternative fan pitch actuation system to implement the automatic blade pitch control of FIG. 1.

FIG. 6 illustrates an alternative fan pitch actuation system to implement the automatic blade pitch control of FIG. 1.

FIG. 7A illustrates a cross sectional view of the fan pitch actuation system of FIGS. 3-6 in a first position.

FIG. 7B illustrates a cross sectional view of the fan pitch actuation system of FIGS. 3-6 in a second position.

FIG. 8 illustrates an alternative implementation of the fan pitch actuation system of FIGS. 3-6.

FIG. 9 is a flowchart representative of example machine-readable instructions and/or operations that may be executed, instantiated, and/or performed by programmable circuitry to implement the full authority digital engine control of FIG. 1.

FIG. 10 is a block diagram of an example processing platform including programmable circuitry structured to execute, instantiate, and/or perform the example machine readable instructions and/or perform the example operations of FIG. 9 to implement the full authority digital engine control of FIG. 1.

The figures are not to scale. Instead, the thickness of regions may be enlarged in the drawings. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” and/or “direct contact” with another part means that there is no intermediate part between the two parts.

### DETAILED DESCRIPTION

Reference now will be made in detail to embodiments or examples of the presently described technology, one or more examples of which are illustrated in the drawings. Each example is provided by way of explanation of the presently described technology, not limitation of the presently described technology. In fact, it will be apparent to those skilled in the art that various modifications and variations can be made in the presently described technology without departing from the scope or spirit of the presently described technology. For instance, features illustrated or described as part of one embodiment or example can be used with another embodiment or example to yield a still further embodiment or example. Thus, it is intended that the presently described technology covers such modifications and variations as come within the scope of the appended claims and their equivalents.

When introducing elements of various embodiments of the present disclosure, the articles “a,” “an,” “the,” and “said” are intended to mean that there are one or more of the elements. As used herein, the terms “first,” “second,” and “third” may be used interchangeably to distinguish one component from another and are not intended to signify location or importance of the individual components. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

The terms “upstream” and “downstream” refer to the relative direction with respect to fluid flow in a fluid pathway. For example, “upstream” refers to the direction from which the fluid flows, and “downstream” refers to the direction to which the fluid flows. As used herein, the terms “axial” and “longitudinal” both refer to a direction parallel to the centerline axis of a gas turbine engine (e.g., a core turbine engine, turbo-machinery, etc.), while “radial” refers to a direction perpendicular to the axial direction, and “tangential” or “circumferential” refers to a direction mutually perpendicular to the axial and radial directions. Accordingly, as used herein, “radially inward” refers to the radial direction from the outer circumference of the gas turbine engine towards the centerline axis of the gas turbine engine, and “radially outward” refers to the radial direction from the centerline axis of the gas turbine engine towards the outer circumference of the gas turbine engine.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a,” “an,” “first,” “second,” etc.) do not exclude a plurality. The term “a” or “an” entity, as used herein, refers to one or more of that entity. The terms “a” (or “an”), “one or more,” and “at least one” can be used interchangeably herein. Additionally, although individual features may be included in different examples or claims, these may possibly be combined, and the inclusion in different examples or claims does not imply that a combination of features is not feasible and/or advantageous.

Some turbo engines used on aircraft, such as turboprop engines, unducted fan (UDF) engines, and high bypass turbofan engines have variable pitch blades or vanes. In particular, the pitch (e.g., angle) of the blades relative to the incoming airflow can be changed during operation of the engine. This enables optimal operation of the turbo engine during the various flight phases. These types of engines include a blade pitch control system to control the pitch of the blades. The blade pitch control system is hydraulically powered. In the event of failure of the hydraulic system and/or engine shut down during flight, it is desirable for the blades to move to a certain pitch position, referred to as a feather position, in which the blades cause the least (e.g., minimal) amount of resistance or drag. In some instances, the feather position corresponds to a position or angle in which the blades are substantially aligned (e.g., ±5°) with the direction of the incoming airflow.

Disclosed herein is an example blade pitch control system having a hydraulic and/or pneumatic system as a failsafe to move the blades to one or more positions/angles (e.g., one or more feathered positions/angles) in the event of failure of the blade pitch control system and/or shut down of the engine. The hydraulic system includes a hydraulic accumulator with configurable solenoid valves. The solenoid valves are controlled based on a trigger to pass fluid from the hydraulic accumulator to a fan pitch actuation system (FPAS). The FPAS controls the pitch of the blades of a propeller based on the fluid flowing into and/or out from the FPAS. Thus, the hydraulic system passively controls the FPAS to change the pitch of the blades of a propeller in response to a trigger (e.g., a power failure, actuation failure, and/or any other trigger).

The pneumatic system includes a pressurized pneumatic chamber that is filled with a pressurized gas, such as nitrogen. The pressurized pneumatic chamber is sealed and provides a constant biasing force in the direction of the feather position. As such, the pressurized pneumatic chamber is loaded at all times during normal operation of the blade pitch control system. However, in the event of failure of the hydraulic oil system and/or engine shut down, the pressurized pneumatic chamber acts in a passive manner to move the blades to the feather position.

Examples disclosed herein move the blades of a propeller into a predefined position (e.g., fully feathered, partially feathered, non-feathered, etc.) passively without active control using a compact and less complex system than traditional techniques. Examples disclosed herein reduce hazardous risk due to feathering failure caused by power loss, pitch control unit (PCU) malfunction, pressure loss, etc.

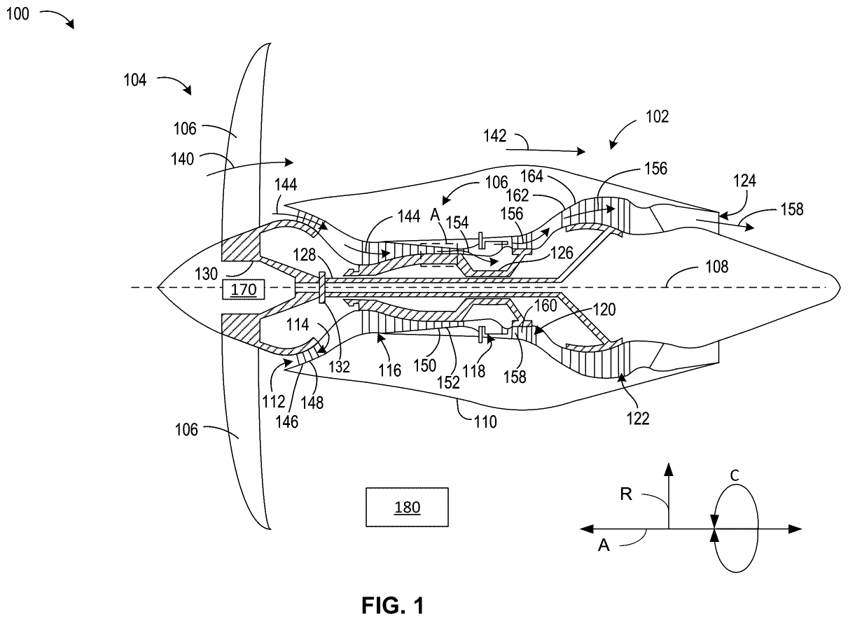

Referring now to the drawings, wherein identical numerals indicate the same elements throughout the figures, FIG. 1 is a schematic cross-sectional view of an example turbo engine 100 that can incorporate various examples disclosed herein. In this example, the turbo engine 100 is a turboprop-type of engine, referred to herein as the turboprop engine 100. However, the principles of the present disclosure are also applicable to other types of engines, such as turbofan engines (e.g., high-bypass turbofan engines, low-bypass turbofan engines), unducted fan (UDF) engines (sometimes referred to as propfans), and/or other types of engines having a propulsor (e.g., a fan, a propeller, etc.) with variable pitch blades or vanes. Further, the examples disclosed herein can also be used in connection with other types of applications, such as electric fans or wind turbines having variable pitch fans.

As shown in FIG. 1, the turboprop engine 100 includes a gas turbine engine 102 (which may also be referred to as a core turbine engine or turbo-machinery) and a propeller 104 including a plurality of blades 106 (sometimes referred to as rotors or vanes). The propeller 104 can include any number of blades 106. The gas turbine engine 102 is disposed downstream from the propeller 104 and drives the blades 106 of the propeller 104 to produce forward thrust. As shown in FIG. 1, the turboprop engine 100 and/or the gas turbine engine 102 define a longitudinal or axial centerline axis 108 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 108, the radial direction R is a direction that extends orthogonally outward from or inward toward the centerline axis 108, and the circumferential direction C is a direction that extends concentrically around the centerline axis 108. Further, as used herein, the term “forward” refers to a direction along the centerline axis 108 in the direction of movement of the turboprop engine 100, such as to the left in FIG. 1, while the term “rearward” refers to a direction along the centerline axis 108 in the opposite direction, such as to the right in FIG. 1.

The gas turbine engine 102 includes a substantially tubular outer casing 110 (which may also be referred to as a mid-casing) that defines an annular inlet 112. The outer casing 110 of the gas turbine engine 102 can be formed from a single casing or multiple casings. The outer casing 110 encloses, in serial flow relationship, a compressor section having a booster or low pressure compressor 114 (“LP compressor 114”) and a high pressure compressor 116 (“HP compressor 116”), a combustion section 118 (which may also be referred to as the combustor 118), a turbine section having a high pressure turbine 120 (“HP turbine 120”) and a low pressure turbine 122 (“LP turbine 122”), and an exhaust section 124. The gas turbine engine 102 includes a high-pressure shaft or spool 126 (“HP shaft 126”) that drivingly couples the HP turbine 120 and the HP compressor 116. The gas turbine engine 102 also includes a low-pressure shaft or spool 128 (“LP shaft 128”) that drivingly couples the LP turbine 122 and the LP compressor 114. The LP shaft 128 also couples to a propeller spool or shaft 130 (sometimes referred to as a fan shaft). The blades 106 are coupled to and extend radially outward from the propeller shaft 130. In this example, the blades 106 are variable pitch blades. As such, the pitch of the blades 106 can be changed during operation of the turboprop engine 100 to improve efficiency and achieve certain flow characteristics during different phases of flight. Example systems for changing the pitch of the blades 106 are disclosed in further detail herein. In some examples, the LP shaft 128 may couple directly to the propeller shaft 130 (i.e., a direct-drive configuration). In alternative configurations, the LP shaft 128 may couple to the propeller shaft 130 via a reduction gear 132 (i.e., an indirect-drive or geared-drive configuration). While in this example the gas turbine engine 102 includes two compressors and two turbines, in other examples, the gas turbine engine 102 may only include one compressor and one turbine.

As illustrated in FIG. 1, during operation of the turboprop engine 100, incoming air 140 enters the propeller 104 and is accelerated by the blades 106. A first portion 142 of the air 140 flows along the outside of the gas turbine engine 102, while a second portion 144 of the air 140 flows into the inlet 112 of the gas turbine engine 102 (and, thus, into the LP compressor 114). One or more sequential stages of LP compressor stator vanes 146 and LP compressor rotor blades 148 coupled to the LP shaft 128 progressively compress the second portion 144 of the air 140 flowing through the LP compressor 114 en route to the HP compressor 116. Next, one or more sequential stages of HP compressor stator vanes 150 and HP compressor rotor vanes 152 coupled to the HP shaft 126 further compress the second portion 144 of the air 140 flowing through the HP compressor 116. This provides compressed air 154 to the combustion section 118 where it mixes with fuel and burns to provide combustion gases 156.

The combustion gases 156 flow through the HP turbine 120 where one or more sequential stages of HP turbine stator vanes 158 and HP turbine rotor blades 160 coupled to the HP shaft 126 extract a first portion of kinetic and/or thermal energy. This energy extraction supports operation of the HP compressor 116. The combustion gases 156 then flow through the LP turbine 122 where one or more sequential stages of LP turbine stator vanes 162 and LP turbine rotor blades 164 coupled to the LP shaft 128 extract a second portion of thermal and/or kinetic energy therefrom. This energy extraction causes the LP shaft 128 to rotate, which supports operation of the LP compressor 114 and/or rotation of the propeller shaft 130. The combustion gases 156 then exit the gas turbine engine 102 through the exhaust section 124 thereof. The combustion gases 156 mix with the first portion 142 of the air 140 to produce propulsive thrust.

Along with the turboprop engine 100, the gas turbine engine 102 serves a similar purpose and sees a similar environment in land-based gas turbines, and turbofan and turbojet engines in which the ratio of the first portion 142 of the air 140 to the second portion 144 of the air 140 is different. In each of the engines, a speed reduction device (e.g., the reduction gear 132) may be included between any shafts and spools. For example, the reduction gear 132 may be disposed between the LP shaft 128 and the propeller shaft 130.

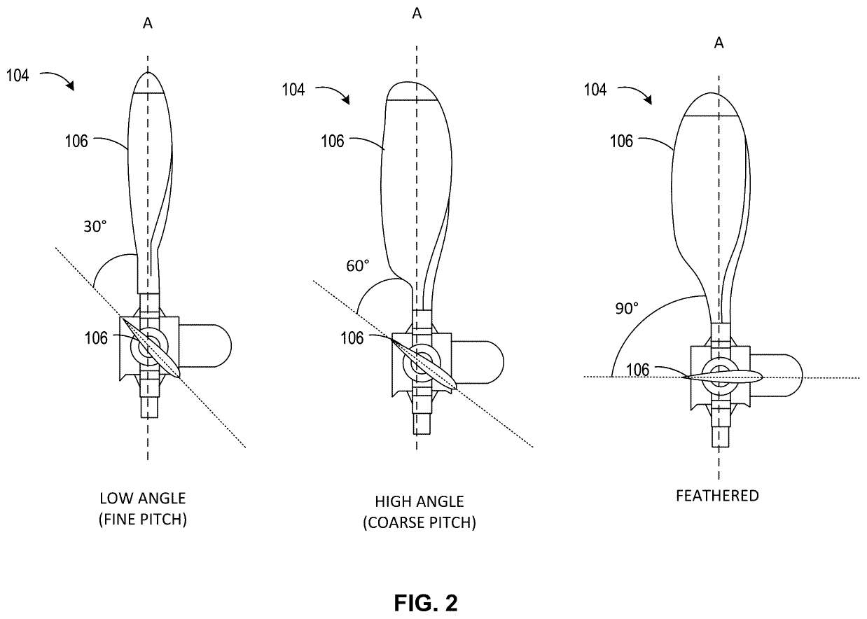

The turboprop engine 100 of FIG. 1 includes an automatic blade pitch control system 170. The automatic blade pitch control system 170 is a system to automatic blade pitch control system 170 of FIG. 1 is a system to automatically and/or passively change the pitch of the blades 106 in response to a trigger. The trigger may be related to a malfunction and/or failure. Accordingly, the automatic blade pitch control system 170 can automatically adjust the pitch of the blade 106 to reduce air drag automatically after a malfunction or error to reduce the hazard associated with the malfunction or error. The trigger may be one or more signals from a full authority digital engine control (FADEC) 180. For example, in response to a power outage or error, the FADEC 180 can be powered by a backup power supply and/or battery and output one or more control signals to the automatic blade pitch control system 170 to cause the automatic blade pitch control system 170 to change the pitch of the blades 106. The automatic blade pitch control system 170 may include a hydraulic and/or pneumatic system for automatically and passively controlling the pitch of the blades 106. The automatic blade pitch control system 170 is further described below in conjunction with FIGS. 2-5.

The FADEC 180 is a controller and/or computing system that controls aspects of engine performance. The FADEC 180 can detect and/or determine an error related to power failure, pressure low, propeller PCU malfunction, and/or any other situation where automatic and/or passive adjustment of the pitch of the blades 106 is needed. The FADEC 180 outputs one or more control signals to the automatic blade pitch control system 170 to change the pitch of the blades 106 (e.g., fine or coarse pitch to a feathered pitch). In some examples, the FADEC 180 can utilize characteristics of the engine and/or flight and/or user/manufacturer preferences to determine what pitch angle to apply the blades 106. For example, the FADEC 180 can cause automatic feathering of the blades 106 based on a triggering event. For example, the FADEC 180 may trigger a first pitch angle (also referred to as a first pitch) for the blades 106 when an error occurs during take off or landing and may use a second pitch angle (also referred to as a second pitch) for the blades 106 when an error occurs during regular flight. Additionally, the FADEC 180 may control the speed of the adjustment of the pitch of the blades 106 based on characteristics of the engine and/or flight and/or user/manufacturer preferences.

FIG. 2 includes side views of blades 106 of the propeller 104 of the turboprop engine 100 of FIG. 1 in three different pitch angles and/or positions (e.g., fine pitch, coarse pitch, and feathered). In the example of FIG. 2, a low angle of the blades 106, also referred to as fine pitch, is an angle that is less than 90 degrees (e.g., 30 degrees) to the plane of rotation (e.g., corresponding to line A). The pitch with the low angle corresponds to a first amount of drag (e.g., high drag). A high angle of the blades 106, also referred to as coarse pitch, is an angle that is greater than the low angle but less than 90 degrees (e.g., 60 degrees) to the plane of rotation. The pitch with the high angle corresponds to a second amount of drag (e.g., medium drag). The feathered angle of the blades 106, also referred to as feathered pitch, is an angle that is 90 degrees to the plane of rotation. The pitch with the feathered angle corresponds to a third amount of drag (e.g., low drag). Although the feathered pitch in the example of FIG. 2 is 90 degrees, as described above, a feathered angle can vary by approximately ±5° from the 90-degree feathered pitch. As described above, the automatic blade pitch control system 170 can, based on a trigger, adjust the pitch from a first angle (e.g., low and/or high) to a second angle (e.g., high and/or feathered). The amount of pitch control and/or speed of pitch control may be based on user/manufacturer preference and/or based on characteristics of the flight and/or turboprop engine 100.

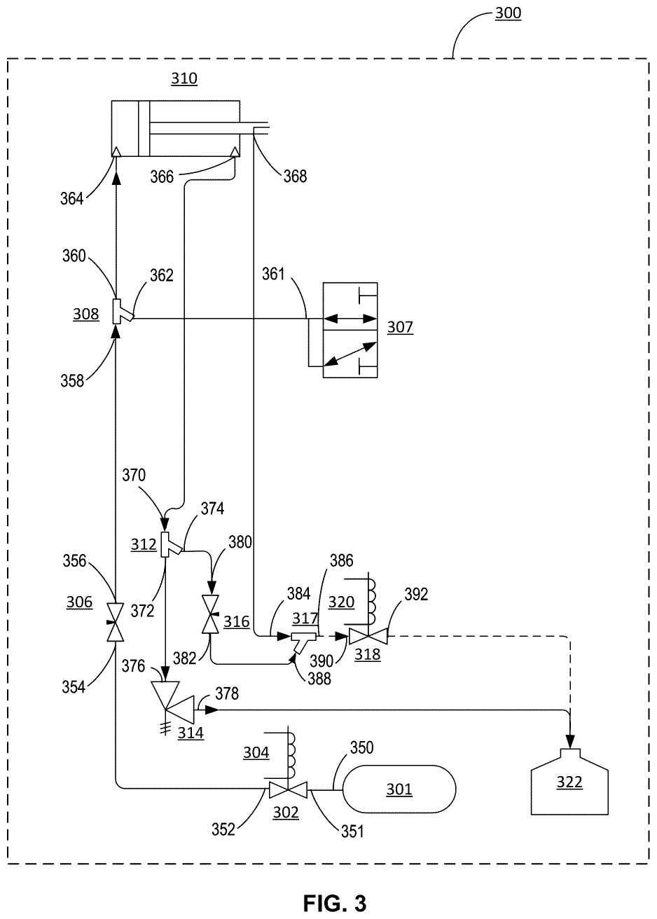

FIG. 3 illustrates an example blade pitch control 300 that may be used to implement the automatic blade pitch control system 170 of FIG. 1. The blade pitch control 300 includes an example accumulator 301, example valves 302, 306, 307, 316, 318, example control coils 304, 320, example connectors 308, 312, 317, an example fan pitch actuation system (FPAS) 310, an example pressure relief valve 314, and an example reservoir 322.

The accumulator 301 of FIG. 3 is a hydraulic energy storage vessel that stores a fluid. The accumulator 301 acts as a pressure vessel to cause the fluid to flow (e.g., to be pumped) into the FPAS 310 (e.g., via the valves 302, 306 (when open) and the connector 308) to cause the blades 106 to change pitch. The fluid may be a water-based fluid, an oil-based fluid, a silicone-based fluid, a synthetic hydrocarbon-based fluid, and/or any other type of hydraulic fluid.

The valve 302 of FIG. 3 is a valve that controls the flow of the hydraulic fluid from the accumulator 301 to the FPAS 310. The valve 302 includes an input 351 (e.g., a connection, an input connection, an inlet, an inlet connection, etc.) that is connected to an output 350 (e.g., a connection, an output connection, an outlet, an outlet connection, etc.) of the accumulator 301 (e.g., via a pipe, hose, tube, etc.) and an output 352 that is connected to an input 354 of the valve 306 (e.g., via a pipe, hose, tube, etc.). When the valve 302 is closed, fluid will not be released from the accumulator 301. However, when the valve 302 is open, the fluid from the accumulator 301 will flow, via the valve 302 toward the valve 306. In some examples, the valve 302 can be partially open (e.g., in a position between fully open and fully closed). In such examples, the valve 302 can control the force of the flow of fluid based on the position of the valve 302 (e.g., how partially open the valve 302 is). The more open the valve, the stronger the force of fluid that will flow, which corresponds to a faster adjustment of the blades 106 to a position (e.g., a feathered position).

The valve 302 can be controlled via the control coil 304 of FIG. 3. The control coil 304 is connected to the FADEC 180 of FIG. 1 via an electrical connection (e.g., a wire, a trace, etc.). When an electrical signal is passed through the control coil 304, the control coil 304 generates a magnetic field that can open or close the valve 302. Accordingly, the FADEC 180 can control the valve 302 by transmitting a signal to the control coil 304. For example, in response to a triggering event, the FADEC 180 outputs a first signal (e.g., a low voltage, a high voltage, or a pulse-width modulated (PWM) voltage depending on the characteristics of the valve 302) to cause the valve 302 to open (e.g., partially or fully). If there is no triggering event, the FADEC 180 can output a second signal different than the first signal (e.g., inverse to the first signal) to cause the valve 302 to close.

The valve 306 of FIG. 3 is structured to control the speed of the adjusting of the pitch of the blades 106 of FIG. 1 by regulating the flow and/or pressure of the liquid from the accumulator 301. For example, the valve 306 may be a flow restriction valve that is structured to adjust the flow and/or pressure to one or more preset values. The valve 306 has an input 354 (e.g., a connection, an input connection, an inlet, an inlet connection, etc.) connected to the output 352 of the valve 302 (e.g., via a pipe, house, tube, etc.) and an output 356 (e.g., connection, output connection, an outlet, an outlet connection, etc.) connected to the first input 358 of the connector 308. The one or more preset values may be based on user/manufacturer preferences and/or may be based on characteristics of the flight and/or turboprop engine 100.

The feather valve 307 of FIG. 3 is a valve that controls the pitch of the blades 106 based on an instruction from a pilot or auto pilot system. The feather valve 307 can output fluid at a particular rate and/or pressure to cause the FPAS 310 to adjust the pitch of the blades 106 of FIG. 1. In the event of an error, fault, malfunction, etc., the feather valve 307 may not work or be able to be controlled. Accordingly, the valves 302, 306, 316, 318 can be controlled to automatically and/or passively adjust the pitch of the blades 106 to mitigate an emergency, as further described below.

The connector 308 of FIG. 3 provides a connection from the accumulator 301 and/or the feather valve 307 to the FPAS 310. The connector 308 includes a first input 358 connected to the output 356 of the valve 306 (e.g., via a pipe, a hose, a tube, etc.), a second input 362 connected to the output 361 of the feather valve 307 (e.g., via a pipe, a hose, a tube, etc.), and the output 360 connected to an input 364 of the FPAS 310. The connector 308 allows fluid from the accumulator 301 and/or the feather valve 307 to flow into the FPAS 310. As described above, the feather valve 307 may be controlled by the FADEC 180 of FIG. 1 during normal operation to adjust the pitch of the blades 106 (e.g., based on pilot control or autopilot control). The accumulator 301, on the other hand, controls the pitch of the blades 106 automatically and/or passively in response to a trigger (e.g., a user request, after an error has been identified by the FADEC, etc.). Accordingly, the connector 308 connects an output 361 of the feather valve 307 with an output of the valve 306 to the FPAS 310 so that either one of the feather valve 307 or the accumulator 301 can control the FPAS 310.

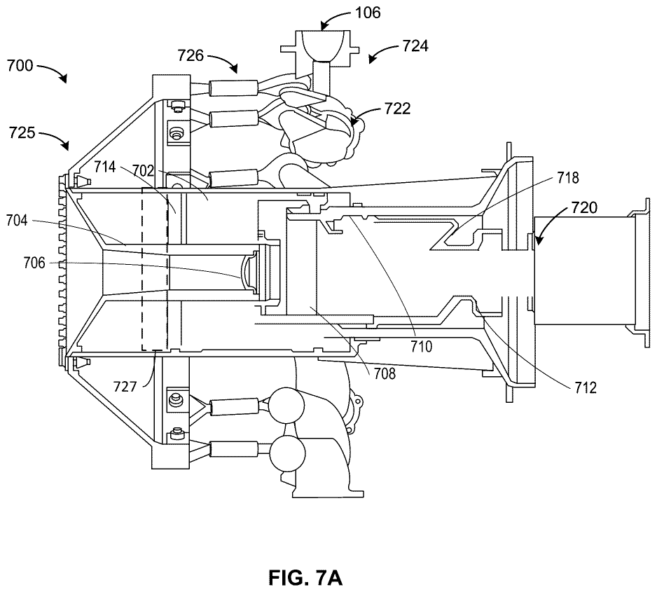

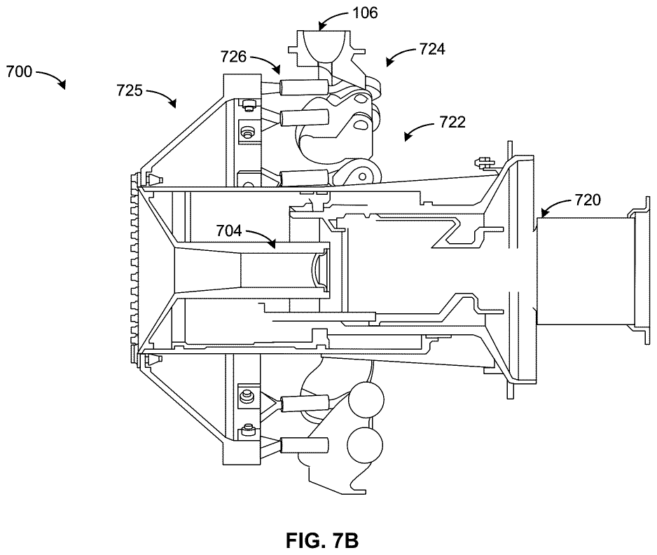

The FPAS 310 of FIG. 3 is a hydraulic based system that can convert hydraulic force into mechanical force based on an amount of hydraulic fluid pumped into the FPAS 310 to adjust the pitch of the blades 106 of FIG. 1. The FPAS 310 has a input 364 (e.g., a connection, an input connection, an inlet, and inlet connection,, etc.) connected to the output 360 of the connector 308 (e.g., via a pipe, a hose, a tube, etc.), a first output 366 (e.g., an output connection, a connection, an outlet, an outlet connection, etc.) connected to an input 370 of the connector 312 (e.g., via a pipe, a hose, a tube, etc.), and a second output 368 (e.g., a connection, an output connection, etc.) connected to the input 384 of the connector 317 (e.g., via a pipe, a hose, a tube, etc.). The FPAS 310 has moveable portions that adjust (e.g., rotate) the pitch of the blades 106 in a first direction (e.g., from a lower angle, such as 30 degrees) toward a higher angle (such as 80-100 degrees) when fluid is pushed into the input 364 via the connector 308. The FPAS 310 adjusts the pitch of the blades 106 in a second direction (e.g., from a higher angle toward a lower angle) when fluid is output from the first output 366 toward the input 370 of the connector 312. Additionally, the FPAS 310 can lock into a position based on the flow of fluid into the FPAS 310 and out from the second output of the FPAS 310 into the connector 317. The FPAS 310 is further described below in conjunction with FIGS. 7-9.

The connector 312 of FIG. 3 provides a connection from the FPAS 310 to the pressure relief valve 314 and/or the valve 316. The connector 312 includes an input 370 connected to the first output 366 of the FPAS 310 (e.g., via a pipe, a hose, a tube, etc.), a first output 372 to the input 376 of the pressure relief valve 314 (e.g., via a pipe, a hose, a tube, etc.), and a second output 374 connected to an input 380 of the valve 316 (e.g., via a pipe, a hose, a tube, etc.). The connector 312 allows fluid from the FPAS 310 to flow toward the pressure relief valve 314 and/or the valve 316. As described above, the FPAS 310 outputs fluid to cause the blades 106 to move from a first pitch to a second pitch.

The pressure relief valve 314 of FIG. 3 keeps the pressure of the fluid from the FPAS 310 below a threshold level (e.g., 2000-2500 pounds per square inch (psi)). The pressure relief valve 314 includes an input 376 connected to the output 372 of the connector 312 (e.g., via a pipe, a hose, a tube, etc.) and an output 378 connected to the reservoir 322 (e.g., via a pipe, a hose, a tube, etc.). The pressure relief valve 314 reduces the pressure of the fluid to prevent pressure-induced damage when causing the fluid to flow into the reservoir 322.

The valve 316 of FIG. 3 is structured to control feather speed by controlling the flow rate through the connector 317. For example, the valve 316 may be a flow restriction valve that is structured to adjust the flow and/or pressure of the fluid from the connector 312 to one or more preset values. The valve 316 has an input 380 connected to the second output 374 of the connector 312 (e.g., via a pipe, house, tube, etc.) and an output 382 connected to a second input 388 of the connector 317.

The connector 317 of FIG. 3 provides a connection from the FPAS 310 and/or the valve 316 to valve 318. The connector 317 includes a first input 384 connected to the second output 368 of the FPAS 310 (e.g., via a pipe, a hose, a tube, etc.), a second input 388 connected to output 382 of the valve 316 (e.g., via a pipe, a hose, a tube, etc.), and an output 386 connected to an input 390 of the valve 318 (e.g., via a pipe, a hose, a tube, etc.). The connector 317 allows fluid from the FPAS 310 and/or the valve 316 to flow toward the valve 318.

The valve 318 of FIG. 3 is a valve that controls the flow of the hydraulic fluid out from the FPAS 310 into the reservoir 322. The valve 318 includes an input 390 that is connected to the output 386 of the connector 317 (e.g., via a pipe, hose, tube, etc.) and an output 392 that is connected to the reservoir 322 (e.g., via a pipe, hose, tube, etc.). When the valve 318 is closed, fluid will not be released from the FPAS 310. However, when the valve 318 is open, the fluid from the FPAS 310 will flow into the reservoir 322. The reservoir 322 stores fluid that flows out from the FPAS 310 (e.g., via the valve 318 and/or the pressure relief valve 314). In some examples, the valve 318 can be partially open (e.g., in a position between fully open and fully closed). In such examples, the valve 318 can control the force of the flow of fluid based on the position of the valve 318 (e.g., based on the amount of open that the valve 318 is). The more open the valve, the stronger the force of fluid that will flow, which corresponds to a faster adjustment of the blades 106 to a position (e.g., a feathered position).

The valve 318 can be controlled via the control coil 320 of FIG. 3. The control coil 320 is connected to the FADEC 180 of FIG. 1 via an electrical connection (e.g., a wire, a trace, etc.). When an electrical signal is passed through the control coil 320, the control coil 320 generates a magnetic field that can open or close the valve 318. Accordingly, the FADEC 180 can control the valve 318 by transmitting a signal to the control coil 320. For example, in response to a triggering event (e.g., a loss of pressure, a loss of power, a malfunction, an error, etc.), the FADEC 180 outputs a first signal (e.g., a low voltage, a high voltage, or a PWM voltage depending on the characteristics of the valve 318) to cause the valve 318 to open (e.g., partially or fully). If there is no triggering event, the FADEC 180 can output a second signal different than the first signal (e.g., inverse to the first signal) to cause the valve 318 to close.

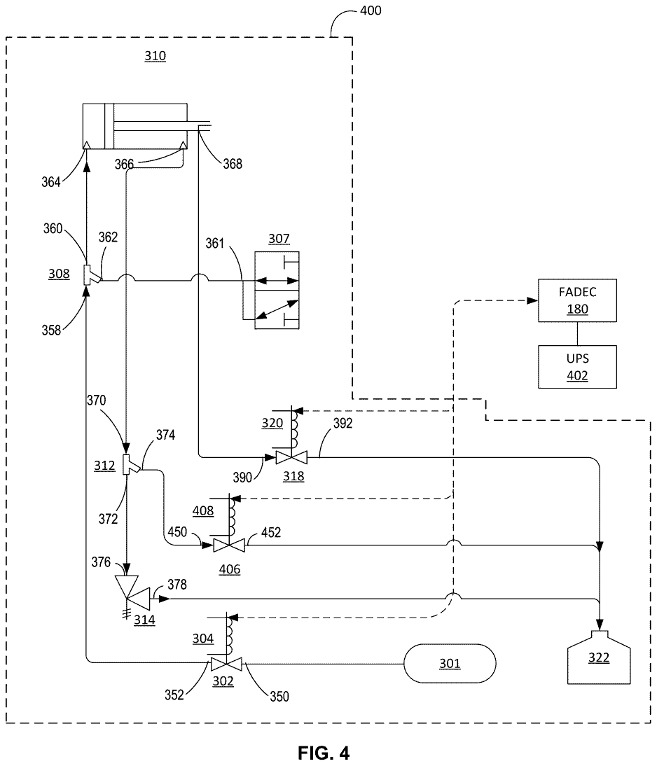

FIG. 4 illustrates an example blade pitch control 400 that may be used to implement the automatic blade pitch control system 170 of FIG. 1. The blade pitch control 400 includes the example accumulator 301, the example valves 302, 318, the example control coils 304, 320, the example connectors 308, 312, the example fan pitch actuation system (FPAS) 310, the example pressure relief valve 314, and the example reservoir 322 of FIG. 3. The blade pitch control 400 includes an example power system, and more particularly, an uninterruptible power supply (UPS) 402, an example valve 406, and an example control coil 408. FIG. 4 further includes the FADEC 180 of FIG. 1.

In the example of FIG. 4, the valve 316 of FIG. 3 is replaced with the valve 406 and an output of the valve 406 is connected to the reservoir 322 as opposed to the connector 317 of FIG. 3. However, the output of the valve 406 could be connected to a connector (e.g., the connector 317 of FIG. 3) to cause fluid to flow into the valve 318. The valve 406 of FIG. 4 is a valve that controls the flow of the hydraulic fluid out from the FPAS 310 (e.g., via the connector 312) into the reservoir 322. The valve 406 includes an input 450 that is connected to the second output 374 of the connector 312 (e.g., via a pipe, hose, tube, etc.) and an output 452 that is connected to the reservoir 322 (e.g., via a pipe, hose, tube, etc.). When the valve 406 is closed, fluid from the FPAS 310 will not flow to the reservoir 322 via the valve 406. However, when the valve 406 is open, the fluid from the FPAS 310 will flow into the reservoir 322 via the valve 406. In some examples, the valve 406 can be partially open (e.g., in a position between fully open and fully closed). In such examples, the valve 406 can control the force of the flow of fluid based on the position of the valve 406 (e.g., how partially open the valve 406 is). The more open the valve, the stronger the force of fluid that will flow. The faster the fluid flows, the faster the blades 106 adjust into a position (e.g., a feathered position). For example, doubling the flow may result in doubling the speed at which the position of the blade moves into position.

The valve 406 can be controlled via the control coil 408 of FIG. 3. The control coil 408 is connected to the FADEC 180 of FIG. 1 via an electrical connection (e.g., a wire, a trace, etc.). When an electrical signal is passed through the control coil 408, the control coil 408 generates a magnetic field that can open or close the valve 406. Accordingly, the FADEC 180 can control the valve 406 by transmitting a signal to the control coil 408. For example, in response to a triggering event (e.g., an indication of pressure loss, power loss, a malfunction, an error, etc.), the FADEC 180 outputs a first signal (e.g., a low voltage, a high voltage, or a PWM voltage depending on the characteristics of the valve 406) to cause the valve 406 to open (e.g., partially or fully). If there is no triggering event, the FADEC 180 can output a second signal different than the first signal (e.g., inverse to the first signal) to cause the valve 406 to close.

FIG. 4 further includes the UPS 402 to power the FADEC 180 regardless of a power failure. The UPS 402 can operate as a backup power supply. Accordingly, in response to a power failure, the FADEC 180 can still send a signal to the valves 302, 318, 406 to control the FPAS 310 to change the pitch of the blades 106. As described above, the FADEC 180 can output control signals (e.g., one or more PWM signals) to the example control coils 304, 320, 408 to control the valves 302, 318, 406, which, in turn, controls the speed at which the pitch of the blades 106 is changed (e.g., to a feathered pitched).

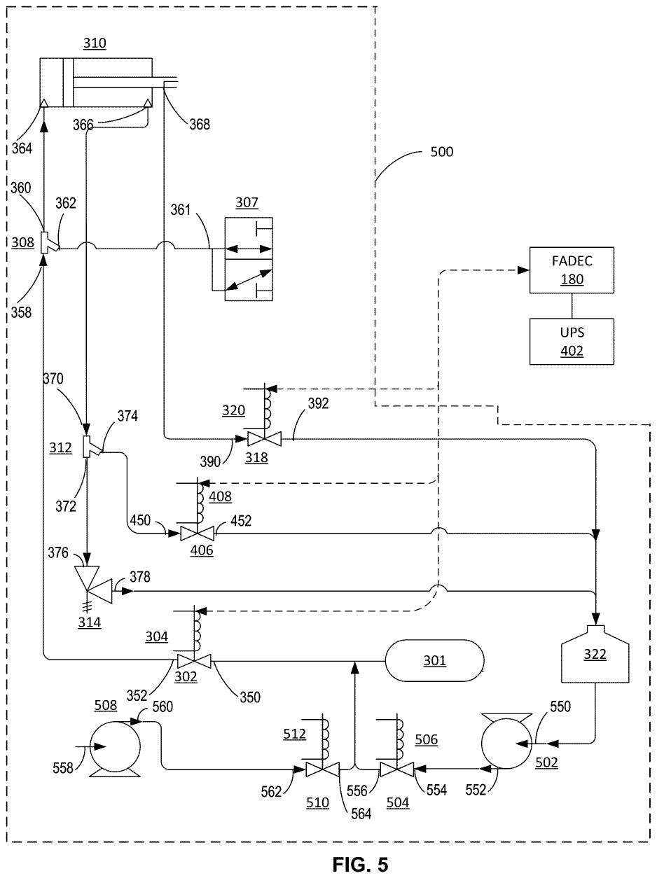

FIG. 5 illustrates an example blade pitch control 500 that may be used to implement the automatic blade pitch control system 170 of FIG. 1. The blade pitch control 500 includes the example accumulator 301, the example valves 302, 318, the example control coils 304, 320, the example connectors 308, 312, the example fan pitch actuation system (FPAS) 310, the example pressure relief valve 314, and the example reservoir 322 of FIG. 3. The blade pitch control 500 further includes the example power system, and more particularly the uninterruptible power supply (UPS) 402, the example valve 406, and the example control coil 408 of FIG. 4. FIG. 5 further includes the FADEC 180 of FIG. 1. The blade pitch control 500 of FIG. 5 further includes example hydraulic sources 502, 508, example valves 504, 510, and example control coils 506, 512.

The hydraulic source 502 of FIG. 5 sources the hydraulic fluid used within the turboprop engine 100. The hydraulic source 502 includes an input 550 connected to the reservoir 322 (e.g., via a pipe, a tube, a hose, etc.) and an output 552 connected to an input 554 the valve 504. The hydraulic source 502 gathers fluid that has been stored in the reservoir 322 and sources the fluid to components of the turboprop engine 100 including the accumulator 301, when depleted or below a threshold. Accordingly, the FADEC 180 can control the valve 504 to refill the accumulator 301 when the fluid is low.

The valve 504 of FIG. 3 is a valve that controls the flow of the hydraulic fluid out from the hydraulic source 502 into the accumulator 301. The valve 504 includes an input 554 that is connected to the output 552 of the hydraulic source 502 (e.g., via a pipe, hose, tube, etc.) and an output 556 that is connected to the accumulator 301 (e.g., via a pipe, hose, tube, etc.). When the valve 504 is closed, fluid from the hydraulic source 502 will not flow to the accumulator 301. However, when the valve 504 is open, the fluid from the FPAS 310 will flow into the accumulator 301. In some examples, the valve 504 can be partially open (e.g., in a position between fully open and fully closed). In such examples, the valve 504 can control the force of the flow of fluid based on the position of the valve 504 (e.g., how partially open the valve 504 is). The more open the valve, the stronger the force of fluid that will flow into the accumulator 301.

The valve 504 can be controlled via the control coil 506 of FIG. 5. The control coil 506 is connected to the FADEC 180 of FIG. 1 via an electrical connection (e.g., a wire, a trace, etc.). When an electrical signal is passed through the control coil 506, the control coil 506 generates a magnetic field that can open or close the valve 504. Accordingly, the FADEC 180 can control the valve 504 by transmitting a signal to the control coil 506. For example, in response to a triggering event (e.g., the accumulator 301 having an amount of fluid below a threshold), the FADEC 180 outputs a first signal (e.g., a low voltage, a high voltage, or a PWM voltage depending on the characteristics of the valve 504) to cause the valve 504 to open (e.g., partially or fully). If there is no triggering event, the FADEC 180 can output a second signal different than the first signal (e.g., inverse to the first signal) to cause the valve 504 to close.

The accumulator 301 is initially charged through the hydraulic power unit for each engine and is controlled by a solenoid or even a simple check valve. As described above, after a triggering event (e.g., an in-flight shutdown (IFSD) and hydraulic power failure) the accumulator 301 is discharged to position the blade 106 of FIG. 1 to a different pitch (e.g., a feathered pitch). After the fluid in the accumulator 301 has depleted past a threshold amount, the FADEC 180 can adjust the valve 504 to restore and/or add fluid to the accumulator 301. However, in an event that the turboprop engine 100 requires an in-flight restart, the hydraulic source 502 may be unavailable for restoring fluid to the accumulator 301. Thus, in response to an in-flight restart, a hydraulic power unit of a second engine (e.g., a second turboprop engine implemented in an aircraft for a second propeller with second blades) can be used to re-charge the accumulator 301.

The hydraulic source 508 of FIG. 5 is a hydraulic source from another engine of the aircraft. For example, the aircraft may have a first engine on the left wing and a second engine on the right wing. If the first engine is restarting, the hydraulic source 508 of the second engine can be used to restore fluid in the accumulator 301 of the first engine. The hydraulic source 508 includes an input 558 that may be connected to a reservoir (e.g., via a pipe, a tube, a hose, etc.) of the second engine and an output 560 connected to an input 562 of the valve 510. The hydraulic source 508 gathers fluid that has been stored in the reservoir of the second engine and sources the fluid to components of the first engine including the accumulator 301, when depleted or below a threshold and/or when the hydraulic source 502 is unavailable. Accordingly, the FADEC 180 can control the valve 510 to refill the accumulator 301 when the pressure of the accumulator 301 is below a threshold amount.

The valve 510 of FIG. 5 is a valve that controls the flow of the hydraulic fluid out from the hydraulic source 508 into the accumulator 301. The valve 510 includes an input 562 that is connected to the output 560 of the hydraulic source 508 (e.g., via a pipe, hose, tube, etc.) and an output 564 that is connected to the accumulator 301 (e.g., via a pipe, hose, tube, etc.). When the valve 510 is closed, fluid from the hydraulic source 508 will not flow to the accumulator 301. However, when the valve 510 is open, the fluid from the FPAS 310 will flow into the accumulator 301. In some examples, the valve 510 can be partially open (e.g., in a position between fully open and fully closed). In such examples, the valve 510 can control the force of the flow of fluid based on the position of the valve 510 (e.g., how partially open the valve 510 is). The more open the valve, the stronger the force of fluid that will flow into the accumulator 301.

The valve 510 can be controlled via the control coil 512 of FIG. 3. The control coil 512 is connected to the FADEC 180 of FIG. 1 via an electrical connection (e.g., a wire, a trace, etc.). When an electrical signal is passed through the control coil 512, the control coil 512 generates a magnetic field that can open or close the valve 510. Accordingly, the FADEC 180 can control the valve 510 by transmitting a signal to the control coil 512. For example, in response to a triggering event (e.g., the fluid in the accumulator 301 going below a threshold and/or an inflight shutdown of the turboprop engine 100), the FADEC 180 outputs a first signal (e.g., a low voltage, a high voltage, or a PWM voltage depending on the characteristics of the valve 510) to cause the valve 510 to open (e.g., partially or fully). If there is no triggering event, the FADEC 180 can output a second signal different than the first signal (e.g., inverse to the first signal) to cause the valve 510 to close.

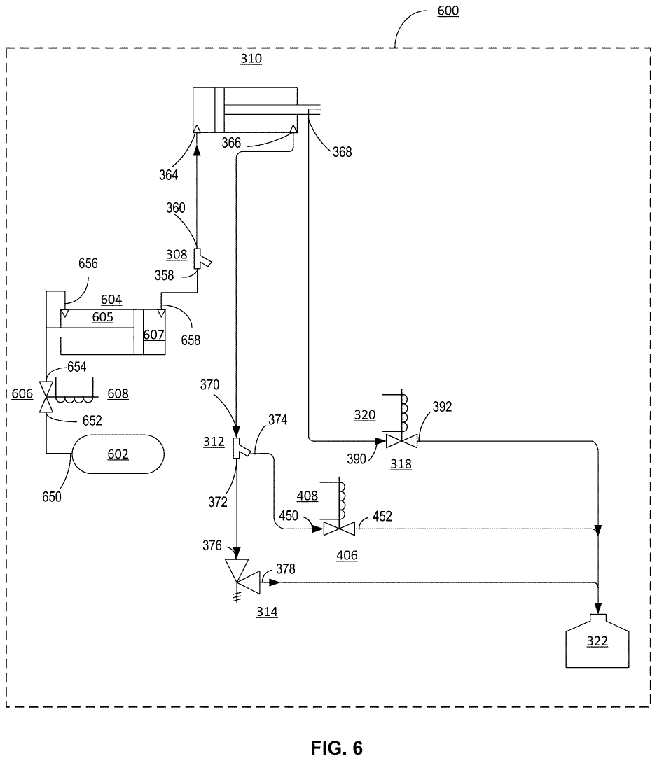

FIG. 6 illustrates an example blade pitch control 600 that may be used to implement the automatic blade pitch control system 170 of FIG. 1. The blade pitch control 600 includes the example valve 318, the example control coil 320, the example connectors 308, 312, the example fan pitch actuation system (FPAS) 310, the example pressure relief valve 314, and the example reservoir 322 of FIG. 3. The blade pitch control 600 further includes the example valve 406 and the example control coil 408 of FIG. 4. The blade pitch control 600 of FIG. 6 further includes an example pneumatic tank 602, an example pneumatic-hydraulic converter 604, an example valve 606, and an example control coil 608.

The pneumatic tank 602 (also referred to as a pneumatic accumulator) of FIG. 6 is a high-pressure tank that outputs a gas to the pneumatic-hydraulic converter 604 when the valve 606 is open. The pneumatic tank 602 includes an outlet 650 (e.g., an output, a connection, an output connection, an outlet connection, etc.) connected to an inlet 652 (e.g., an input, a connection, an input connection, an inlet connection, etc.) of the valve 606 (e.g., via a pipe, a hose, a tube, etc.). Although the pneumatic tank 602 of FIG. 6 stores nitrogen, the pneumatic tank 602 can store a different type of gas.

The pneumatic-hydraulic converter 604 of FIG. 6 includes a first portion 605 that can be filled with the gas from the pneumatic tank 602 and a second portion 607 filled with hydraulic fluid. The pneumatic-hydraulic converter 604 includes an input 656 connected to an output 654 of the valve 606 (e.g., via a pipe, a hose, a tube, etc.) and an output 658 connected to the first input 358 of the connector 308. The pneumatic tank 602 with high pressure gas is used to energize the pneumatic-hydraulic converter 604 (including a double acting cylinder) and to apply force to the second portion 607 (e.g., chamber which contained hydraulic fluid) to cause the hydraulic fluid to flow into the FPAS 310 via the connector 308. The volume of hydraulic source in the pneumatic-hydraulic converter 604 is capable of, when the valve 606 is open, filling the volume of a chamber in FPAS 310 to adjust the pitch of the blades 106.

The valve 606 of FIG. 6 is a valve that controls the flow of the pneumatic gas from the pneumatic tank 602 to the pneumatic-hydraulic converter 604. The valve 606 includes an inlet 652 that is connected to the outlet 650 of the pneumatic tank 602 (e.g., via a pipe, hose, tube, etc.) and an output 654 that is connected to the input 656 of the pneumatic-hydraulic converter 604 (e.g., via a pipe, hose, tube, etc.). When the valve 606 is closed, gas is not released from the pneumatic tank 602. However, when the valve 606 is open, the gas from the pneumatic tank 602 flows, via the valve 606 into the pneumatic-hydraulic converter 604. In some examples, the valve 606 can be partially open (e.g., in a position between fully open and fully closed). In such examples, the valve 606 can control the force of the flow of gas based on the position of the valve 606 (e.g., how partially open the valve 606 is). The more open the valve, the stronger the force of gas that flows, which corresponds to a fast release of hydraulic fluid into the FPAS 310. The faster the flow of hydraulic fluid into the FPAS 310, the faster the adjustment of the blades 106 to a position (e.g., a feathered position).

The valve 606 can be controlled via the control coil 608 of FIG. 6. The control coil 608 is connected to the FADEC 180 of FIG. 1 via an electrical connection (e.g., a wire, a trace, etc.). When an electrical signal is passed through the control coil 608, the control coil 608 generates a magnetic field that can open or close the valve 606. Accordingly, the FADEC 180 can control the valve 606 by transmitting a signal to the control coil 608. For example, in response to a triggering event (e.g., pressure loss, power loss, malfunction, error, etc.), the FADEC 180 outputs a first signal (e.g., a low voltage, a high voltage, or a PWM voltage depending on the characteristics of the valve 606) to cause the valve 606 to open (e.g., partially or fully). If there is no triggering event, the FADEC 180 can output a second signal different than the first signal (e.g., inverse to the first signal) to cause the valve 606 to close.

FIGS. 7A and 7B illustrate a cross-sectional view of an example implementation of the FPAS 310 of FIGS. 2-6 in two positions. The FPAS 310 of FIGS. 7A and/or 7B includes an example housing 700, an example housing support 702, an example inner shaft 704, an example plug 706, a first example chamber 708, a second example chamber 710, an example pitch lock line 712, an example mechanical pitch lock 714, an example oil transfer bearing assembly 718, an example connector 720, example spherical bearings 722, an example crankshaft 724, an example arm housing 725, and example arms 726, and an example pneumatic chamber 727. FIGS. 7A and 7B also illustrate a portion of the blade 106 of FIG. 1.

The housing 700 of FIG. 7A houses the interior components of the FPAS 310. In the example of FIG. 7, the housing 700 is cylindrical. However, the housing 700 may correspond to a different shape. The housing 700 is supported by the housing support 702. The inner shaft 704 is a moveable shaft that moves from a first position to a second position based on the amount and/or force of fluid and/or gas in the chamber 708 and/or 710. The inner shaft 704 of FIGS. 7A and/or 7B is hollow. Accordingly, the inner shaft 704 includes a plug to prevent fluid from entering into an interior of the inner shaft. 704. However, the inner shaft 704 may not be hollow.

The first example chamber 708 of FIG. 7A can house fluid that is obtained (e.g., received) from the accumulator 301 of FIGS. 3-5 and/or the pneumatic-hydraulic converter 604 of FIGS. 7A and/or 7B (e.g., via the connector 308). As the fluid is pushed through the connector 720, the chamber 708 fills up, which moves (e.g., pushes) the inner shaft 704 outward away from the connector 720. As further described below, as the inner shaft 704 is pushed outward, the blades 106 adjust pitch toward a feathered pitch. The second example chamber 710 houses fluid as it is released out to return to the reservoir 322 of FIGS. 3-6. As the fluid is released, the inner shaft 704 may, if not locked, move inward toward the connector 720. The closer the inner shaft 704 is to the connector 720, the lower the pitch angle (e.g., the finer the pitch).

The pitch lock line 712 of FIG. 7A houses fluid that is used to lock the position of the inner shaft 704 regardless of the force and/or amount of fluid in the chamber(s) 708, 710. The fluid in the pitch lock line 712 can lock the inner shaft 704 using the mechanical pitch lock 714, which is controlled by the amount and/or force of fluid in the pitch lock line 712.

The oil transfer bearing assembly 718 includes a rotational bearing and a number of flow pathways allowing the FPAS 310 of FIGS. 2-6 to rotate and to operate with supplied hydraulic pressure. The oil transfer bearing assembly 718 is a compartment/shaft with a bearing and an internal cavity for the hydraulic input and output.

The spherical bearing 722 of FIG. 7A is attached to the inner shaft 704 via one or more connections. The spherical bearing 722 rotates as the inner shaft 704 moves. For example, the spherical bearing 722 rotates in a first direction when the inner shaft 704 moves away from the connector 720 and rotates in a second direction when the inner shaft 704 moves toward the connector 720. The spherical bearing 722 is also connected to the crankshaft 724. The crankshaft 724 twists with the rotation of the spherical bearing 722. The crankshaft 724 is connected to one of the blades 106. The spherical bearing 722 and crankshaft 724 translate the linear movement of the inner shaft 704 into rotational movement of the blade 106. For example, when the inner shaft 704 moves outward, the spherical bearing 722 and crankshaft 724 rotate the blade 106 towards a feathering pitch. When the inner shaft 704 moves inward, the spherical bearing 722 and the crankshaft 724 rotate the blade 106 toward a low angle pitch (e.g., a fine pitch). The FPAS 310 has a spherical bearing 722 and crankshaft 724 for each blade 106.

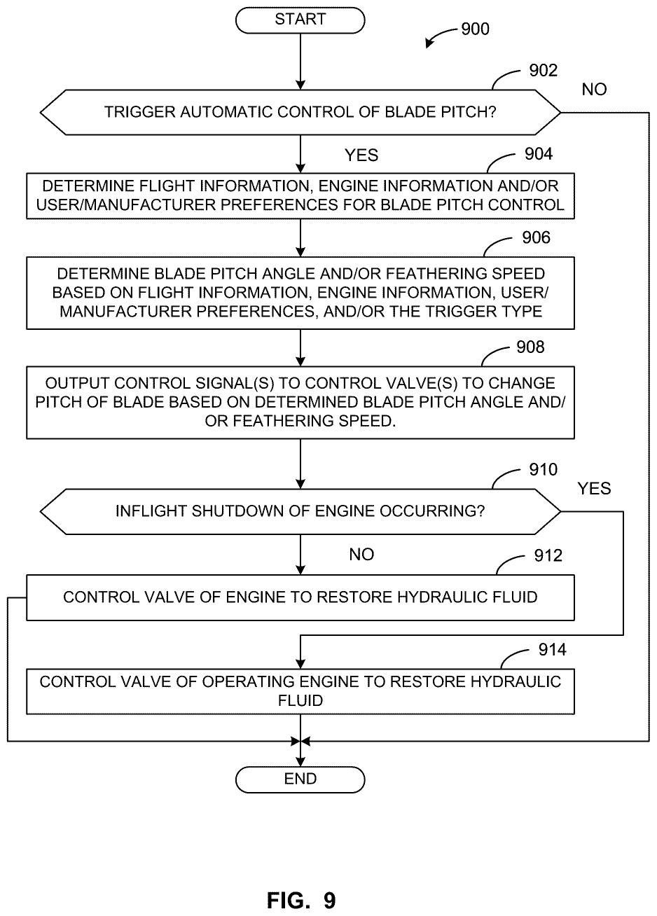

The FPAS 310 further includes an optional pneumatic chamber 727. The pneumatic chamber 727 may be included to provide additional pressure and/or force using gas to adjust the inner shaft 704. The pneumatic chamber 727 can house gas that can be used to push the inner shaft 704 outward. The pneumatic chamber 727 can be used in addition to and/or as an alternative to the chamber 708. For example, the pneumatic chamber 727 can be used with the chamber 708 to more quickly push out the inner shaft 704 using both pneumatic pressure and hydraulic pressure. In another example, the pneumatic chamber 727 can be used when there is a failure related to the hydraulic system. Control of the gas into the pneumatic chamber 727 is further described below in conjunction with FIG. 9.

FIG. 7A illustrates the FPAS 310 in a first, feathered pitch position and FIG. 7B illustrates the FPAS 310 in a second, fine pitch position.

In the first position of FIG. 7A, the inner shaft 704 is positioned outward, away from the connector 720. The arm housing 725 is connected to the inner shaft 704 and the arms 726. Accordingly, when the inner shaft 704 is pushed outward, the arm housing 725 moves (e.g., pulls) the arms 726 outward. The arms 726 are connected to the crankshaft 724. Accordingly, when the arms 726 are pushed outward, the crankshaft 724 rotates the blades 106 into a feathered pitch.

In the second position of FIG. 7B, the inner shaft 704 is inward, toward from the connector 720. The arm housing 725 is connected to the inner shaft 704 and the arms 726. Accordingly, when the inner shaft 704 is pushed inward, the arm housing 725 moves (e.g., pushes) the arms 726 inward. The arms 726 are connected to the crankshaft 724. Accordingly, when the arms 726 are pushed inward, the crankshaft 724 rotates the blades 106 into a fine pitch.

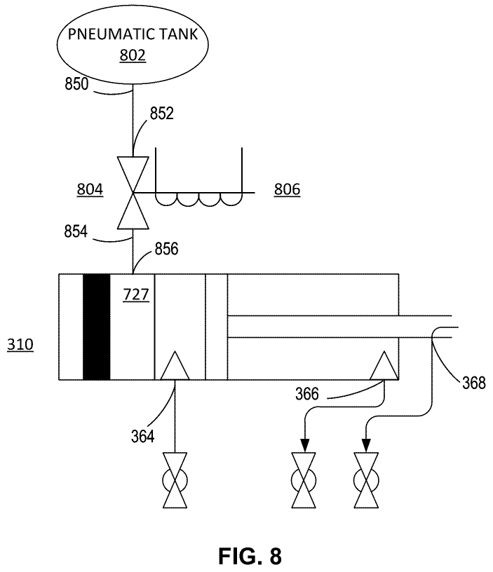

FIG. 8 illustrates components for pneumatic control of the FPAS 310 of FIGS. 2-7B. FIG. 8 includes the pneumatic chamber 727 of FIG. 7. FIG. 8 further includes an example pneumatic tank 802, an example valve 804, and an example control coil 806.

The pneumatic tank 802 (also referred to as a pneumatic accumulator) of FIG. 8 is a high-pressure tank that outputs a gas to the pneumatic chamber 727 when the valve 804 is open. The pneumatic tank 802 includes an output 850 connected to an input 852 of the valve 804 (e.g., via a pipe, a hose, a tube, etc.). Although the pneumatic tank 602 of FIG. 6 stores nitrogen, the pneumatic tank 802 can store a different type of gas.

The valve 804 of FIG. 8 is a valve that controls the flow of the pneumatic gas from the tank 802 to the pneumatic chamber 727. The valve 804 includes an input 852 that is connected to the output 850 of the pneumatic tank 802 (e.g., via a pipe, hose, tube, etc.) and an output 854 that is connected to a second input 856 of the pneumatic chamber 727 (e.g., via a pipe, hose, tube, etc.). When the valve 804 is closed, gas is not released from the pneumatic tank 802. However, when the valve 804 is open, the gas from the pneumatic tank 802 flows, via the valve 804 into the pneumatic chamber 727. In some examples, the valve 804 can be partially open (e.g., in a position between fully open and fully closed). In such examples, the valve 804 can control the force of the flow of gas based on the position of the valve 804 (e.g., how partially open the valve 804 is). The more open the valve 804, the stronger the force of gas that flows, which corresponds to a fast release of pneumatic gas into the FPAS 310. The faster the flow of pneumatic gas into the FPAS 310, the faster the adjustment of the blades 106 to a position (e.g., a feathered position).

The valve 804 of FIG. 8 can be controlled via the control coil 806 of FIG. 8. The control coil 806 is connected to the FADEC 180 of FIG. 1 via an electrical connection (e.g., a wire, a trace, etc.). When an electrical signal is passed through the control coil 806, the control coil 806 generates a magnetic field that can open or close the valve 804. Accordingly, the FADEC 180 can control the valve 804 by transmitting a signal to the control coil 806. For example, in response to a triggering event, the FADEC 180 outputs a first signal (e.g., a low voltage, a high voltage, or a PWM voltage depending on the characteristics of the valve 804) to cause the valve 804 to open (e.g., partially or fully). If there is no triggering event, the FADEC 180 can output a second signal different than the first signal (e.g., inverse to the first signal) to cause the valve 804 to close.

While an example manner of implementing the FADEC 180 of FIG. 1 is illustrated in FIG. 1, one or more of the elements, processes, and/or devices illustrated in FIG. 1 may be combined, divided, re-arranged, omitted, eliminated, and/or implemented in any other way. Further, the example FADEC 180 of FIG. 1, may be implemented by hardware alone or by hardware in combination with software and/or firmware. Thus, for example, the example FADEC 180, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example FADEC 180 of FIG. 1 may include one or more elements, processes, and/or devices in addition to, or instead of, those illustrated in FIG. 1, and/or may include more than one of any or all of the illustrated elements, processes and devices.

A flowchart representative of example machine readable instructions, which may be executed by programmable circuitry to implement and/or instantiate the FADEC 180 of FIG. 1 and/or representative of example operations which may be performed by programmable circuitry to implement and/or instantiate the FADEC 180 of FIG. 1, is shown in FIG. 9. The machine readable instructions may be one or more executable programs or portion(s) of one or more executable programs for execution by programmable circuitry such as the programmable circuitry 1012 shown in the example processor platform 1000 discussed below in connection with FIG. 11 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 9, many other methods of implementing the example FADEC 180 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by programmable circuitry to control the automatic blade pitch control system 170 of FIGS. 1 and 3-6. The example machine-readable instructions and/or the example operations 900 of FIG. 9 begin at block 902, at which the FADEC 180 determines whether to trigger automatic control of the pitch of the blades 106. For example, the FADEC 180 can obtain triggers when an error, malfunction, etc. occurs. The FADEC 180 can trigger automatic control of the pitch of the blades 106 based on identified issue were increasing the angle of the blades 106 would be helpful and/or lifesaving. The events that cause the FADEC 180 to automatically trigger control of the blade pitch may be based on pilot and/or manufacturer preferences.

If the FADEC 180 determines that it is not necessary to trigger automatic blade pitch control (block 902: NO), the instructions end. If the FADEC 180 determines that it is necessary to trigger automatic blade pitch control (block 902: YES), the FADEC 180 determines the flight/engine information and/or user/manufacturer preferences for blade pitch control (block 904). For example, the FADEC 180 can determine whether the aircraft is ascending, level, or descending, information from sensors in the aircraft, information related to control of the engine(s), etc. Additionally, a user and/or manufacturer may define preferences for how to adjust the pitch of the blades 160 in response to a trigger. At block 906, the FADEC 180 determines a blade pitch angle and/or feathering speed based on the flight information, engine information, user/manufacturer preference, and/or the trigger type (e.g., the detected event that led to the trigger).

At block 908, the FADEC 180 outputs one or more control signal(s) to one or more of the control coil(s) 304, 320, 408, 608, 806 of the valve(s) 302, 318, 406, 606, 804, respectively, to change the pitch of blades 106 based on the determined blade pitch angle and/or feathering speed. For example, the FADEC 180 can output a high voltage to the one or more of the control coils 304, 320, 408, 608, 806 of the valve(s) 302, 318, 406, 606,804, respectively, to quickly adjust the pitch of the blades 106. However, the FADEC 180 can output a PWM signal to one or more of the control coils 304, 320, 408, 608, 806 of the valve(s) 302, 318, 406, 606, 804, respectively, to adjust the pitch of the blades 106 at a particular speed (e.g., based on user/manufacturer preferences and/or flight/engine characteristics).

At block 910, the FADEC 180 determines if an inflight shutdown of the engine 100 is occurring. As described above in conjunction with FIG. 5, if an inflight shutdown of the engine 100 is occurring, the hydraulic source 502 may not be available to resupply the accumulator 301. If the FADEC 180 determines that an inflight shutdown of the engine 100 is not occurring (block 910: NO), the FADEC 180 outputs a control signal to the control coil 506 to open the valve 504 to restore the hydraulic fluid in the accumulator 301 by providing a path from the hydraulic source 502 to the accumulator 301 (block 912). If the FADEC 180 determines that an inflight shutdown of the engine 90 is occurring (block 910: YES), the FADEC 180 outputs a control signal to the control coil 512 to open the valve 510 to restore the hydraulic fluid in the accumulator 301 by providing a path from the hydraulic source 508 of a second engine to the accumulator 301 (block 914).

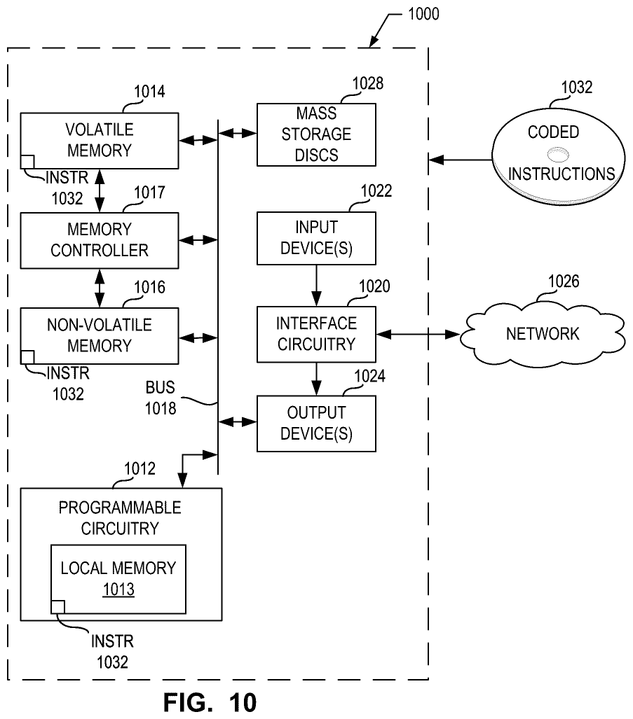

FIG. 10 is a block diagram of an example programmable circuitry platform 1000 structured to execute and/or instantiate the example machine-readable instructions and/or the example operations of FIG. 9 to implement the FADEC 180 of FIG. 1. The programmable circuitry platform 1000 can be, for example, a server, a computer, a controller, a self-learning machine (e.g., a neural network), or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

Machine readable instructions 1032, which may be implemented by the machine readable instructions of FIG. 9, may be stored in the mass storage device 1028, in the volatile memory 1014, in the non-volatile memory 1016, and/or on at least one non-transitory computer readable storage medium such as a CD or DVD which may be removable.

From the foregoing, it will be appreciated that example systems, apparatus, articles of manufacture, and methods have been disclosed to control pitch of a propeller blade. Disclosed herein is an example blade pitch control system having a hydraulic and/or pneumatic system as a failsafe to move the blades to one or more positions (e.g., one or more feathered positions) to reduce drag in the event of failure of the blade pitch control system and/or shut down of the engine. Accordingly, examples disclosed herein improve the safety of aircrafts in the event of such occurrence. Thus, the disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to control pitch of a propeller blade are disclosed herein. Further aspects of the present disclosure are provided by the subject matter of the following clauses.

A turbo engine including a propeller including a blade, the blade rotatable about a centerline axis to change a pitch of the blade, and a blade pitch control system including a fan pitch actuation system coupled to the blade, the fan pitch actuation system moveable to rotate the blade from a first pitch angle to a second pitch angle based on an amount of hydraulic fluid pumped into the fan pitch actuation system, an accumulator to store the hydraulic fluid, and a valve coupled to an output of the accumulator and an input of the fan pitch actuation system, the valve to automatically provide the hydraulic fluid from the accumulator to the fan pitch actuation system based on a control signal.

The turbo engine according to the preceding clause, further including a controller to output the control signal to a control coil, wherein the control signal being applied to the control coil causes the valve to open.

The turbo engine according to any preceding clause, wherein the valve is a first valve, and wherein the turbo engine further includes a connector coupled to an output of the fan pitch actuation system, a pressure relief valve coupled to the connector, a second valve coupled to the connector, and a reservoir coupled to the pressure relief valve and the second valve.

The turbo engine according to any preceding clause, wherein the control signal is a first control signal, and wherein the turbo engine further includes a controller to output a second control signal to a control coil, wherein the control signal being applied to the control coil causes the second valve to open.

The turbo engine according to any preceding clause, further including a reservoir to store the hydraulic fluid output from the fan pitch actuation system.

The turbo engine according to any preceding clause, wherein the valve is a first valve, and wherein the turbo engine further includes a hydraulic source coupled to the reservoir, the hydraulic source to receive the hydraulic fluid from the reservoir, and a second valve coupled to the hydraulic source and the accumulator, the second valve to, when open, cause the hydraulic fluid in the hydraulic source to flow into the accumulator.

The turbo engine according to any preceding clause, further including a controller to output the control signal to a control coil, wherein the control signal being applied to the control coil causes the second valve to open.

The turbo engine according to any preceding clause, wherein the turbo engine is a first turbo engine and the valve is a first valve, and wherein the turbo engine further includes a second valve coupled to a hydraulic source included in a second turbo engine and the accumulator, the second valve to, when open, cause the hydraulic fluid in the hydraulic source to flow into the accumulator.

The turbo engine according to any preceding clause, wherein the fan pitch actuation system includes an inner shaft, and a crankshaft coupled to the inner shaft and the blade, the crankshaft to translate linear movement of the inner shaft to rotational movement of the blade, a first chamber to receive the hydraulic fluid, the hydraulic fluid to cause the inner shaft to move in a first direction, and a second chamber to receive pneumatic gas, the pneumatic gas to cause the inner shaft to move in the first direction.

The turbo engine according to any preceding clause, further including a controller to cause automatic feathering of the blade by sending a signal to a control coil to open the valve.

An apparatus comprising a fan pitch actuation system coupled to a blade of a propeller, the fan pitch actuation system moveable in a first direction to rotate the blade from a first pitch angle to a second pitch angle based on an amount of hydraulic fluid pumped into the fan pitch actuation system, an accumulator to store the hydraulic fluid, a valve coupled to an output of the accumulator and an input of the fan pitch actuation system, the valve to, when open provide the hydraulic fluid from the accumulator to the fan pitch actuation system based on a control signal, and a controller to detect a triggering event, and based on at least one of user preferences, flight characteristics, or engine characteristics, output the control signal to open the valve based on the detected triggering event.

The turbo engine according to the preceding clause, wherein the triggering event is at least one of a malfunction or an error.

The turbo engine according to any preceding clause, wherein the valve is a first valve, wherein the apparatus further includes a connector coupled to an output of the fan pitch actuation system, a pressure relief valve coupled to the connector, a second valve coupled to the connector, and a reservoir coupled to the pressure relief valve and the second valve.

The turbo engine according to any preceding clause, wherein the control signal is a first control signal, wherein the apparatus further includes a controller to output a second control signal to a control coil, wherein the control signal being applied to the control coil causes the second valve to open.

The turbo engine according to any preceding clause, further including a reservoir to store the hydraulic fluid output from the fan pitch actuation system.

The turbo engine according to any preceding clause, wherein the valve is a first valve, wherein the apparatus further includes a hydraulic source coupled to the reservoir, the hydraulic source to receive the hydraulic fluid from the reservoir, and a second valve coupled to the hydraulic source and the accumulator, the second valve to, when open, cause the hydraulic fluid in the hydraulic source to flow into the accumulator.

The turbo engine according to any preceding clause, wherein the controller is to output the control signal to a control coil, wherein the control signal being applied to the control coil causes the second valve to open.

The turbo engine according to any preceding clause, wherein the valve is a first valve and the fan pitch actuation system, the accumulator, and first valve is included in a first engine, wherein the apparatus further includes a second valve coupled to a hydraulic source included in a second engine and the accumulator, the second valve to, when open, cause the hydraulic fluid in the hydraulic source to flow into the accumulator.

An apparatus comprising interface circuitry to output a control signal to a valve to cause a blade of a propeller to automatically change from a first pitch angle to a second pitch angle, machine readable instructions, and at least one programmable circuit to at least one of execute or instantiate the machine readable instructions to at least determine at least one of a flight information, engine information, or pilot preferences, and based on a triggering event, generate the control signal based on the at least one of the flight information, the engine information, or the pilot preferences.

The turbo engine according to the preceding clause, wherein the valve is a first valve, the control signal is a first control signal, and the first valve and the blade are included in a first engine, the at least one programmable circuit to determine whether an inflight shutdown is occurring, and at least one of output a second control signal to cause a second valve to restore hydraulic fluid to an accumulator from a first hydraulic source of the first engine based on the inflight shutdown occurring, or output a third control signal to cause a third valve to restore hydraulic fluid to the accumulator of the first engine from a second hydraulic source of a second engine based on the inflight shutdown not occurring.

A method comprising outputting a control signal to a valve to cause a blade of a propeller to automatically change from a first pitch angle to a second pitch angle; determining at least one of a flight information, engine information, or pilot preferences; and based on a triggering event, generating the control signal based on the at least one of the flight information, the engine information, or the pilot preferences.

The method according to the preceding clause, wherein the valve is a first valve, the control signal is a first control signal, and the first valve and the blade are included in a first engine, further including determining whether an inflight shutdown is occurring.

The method according to any preceding clause, further including outputting a second control signal to cause a second valve to restore hydraulic fluid to an accumulator from a hydraulic source of the first engine based on the inflight shutdown occurring.

The method according to any preceding clause, further including outputting a second control signal to cause a second valve to restore hydraulic fluid to an accumulator of the first engine from a hydraulic source of a second engine based on the inflight shutdown not occurring.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A turbo engine comprising:
a propeller including a blade, the blade rotatable about a centerline axis to change a pitch of the blade; and
a blade pitch control system including:
a fan pitch actuation system coupled to the blade, the fan pitch actuation system moveable to rotate the blade from a first pitch angle to a second pitch angle based on an amount of hydraulic fluid pumped into the fan pitch actuation system;
an accumulator to store the hydraulic fluid; and
a valve coupled to an output of the accumulator and an input of the fan pitch actuation system, the valve to automatically provide the hydraulic fluid from the accumulator to the fan pitch actuation system based on a control signal.

2. The turbo engine of claim 1, further including a controller to output the control signal to a control coil, wherein the control signal being applied to the control coil causes the valve to open.

3. The turbo engine of claim 1, wherein the valve is a first valve, and wherein the turbo engine further includes:
a connector coupled to an output of the fan pitch actuation system;
a pressure relief valve coupled to the connector;
a second valve coupled to the connector; and
a reservoir coupled to the pressure relief valve and the second valve.

4. The turbo engine of claim 3, wherein the control signal is a first control signal, and wherein the turbo engine further includes a controller to output a second control signal to a control coil, wherein the control signal being applied to the control coil causes the second valve to open.

5. The turbo engine of claim 1, further including a reservoir to store the hydraulic fluid output from the fan pitch actuation system.

6. The turbo engine of claim 5, wherein the valve is a first valve, and wherein the turbo engine further includes:
a hydraulic source coupled to the reservoir, the hydraulic source to receive the hydraulic fluid from the reservoir; and
a second valve coupled to the hydraulic source and the accumulator, the second valve to, when open, cause the hydraulic fluid in the hydraulic source to flow into the accumulator.

7. The turbo engine of claim 6, further including a controller to output the control signal to a control coil, wherein the control signal being applied to the control coil causes the second valve to open.

8. The turbo engine of claim 5, wherein the turbo engine is a first turbo engine and the valve is a first valve, and wherein the turbo engine further includes:
a second valve coupled to a hydraulic source included in a second turbo engine and the accumulator, the second valve to, when open, cause the hydraulic fluid in the hydraulic source to flow into the accumulator.

9. The turbo engine of claim 1, wherein the fan pitch actuation system includes:
an inner shaft; and
a crankshaft coupled to the inner shaft and the blade, the crankshaft to translate linear movement of the inner shaft to rotational movement of the blade;
a first chamber to receive the hydraulic fluid, the hydraulic fluid to cause the inner shaft to move in a first direction; and
a second chamber to receive pneumatic gas, the pneumatic gas to cause the inner shaft to move in the first direction.

10. The turbo engine of claim 1, further including a controller to cause automatic feathering of the blade by sending a signal to a control coil to open the valve.

11. An apparatus comprising:
a fan pitch actuation system coupled to a blade of a propeller, the fan pitch actuation system moveable in a first direction to rotate the blade from a first pitch angle to a second pitch angle based on an amount of hydraulic fluid pumped into the fan pitch actuation system;
an accumulator to store the hydraulic fluid;
a valve coupled to an output of the accumulator and an input of the fan pitch actuation system, the valve to, when open provide the hydraulic fluid from the accumulator to the fan pitch actuation system based on a control signal; and
a controller to:
detect a triggering event; and
based on at least one of user preferences, flight characteristics, or engine characteristics, output the control signal to open the valve based on the detected triggering event.

12. The apparatus of claim 11, wherein the triggering event is at least one of a malfunction or an error.

13. The apparatus of claim 11, wherein the valve is a first valve, wherein the apparatus further includes:
a connector coupled to an output of the fan pitch actuation system;
a pressure relief valve coupled to the connector;
a second valve coupled to the connector; and
a reservoir coupled to the pressure relief valve and the second valve.

14. The apparatus of claim 13, wherein the control signal is a first control signal, wherein the apparatus further includes a controller to output a second control signal to a control coil, wherein the control signal being applied to the control coil causes the second valve to open.

15. The apparatus of claim 11, further including a reservoir to store the hydraulic fluid output from the fan pitch actuation system.

16. The apparatus of claim 15, wherein the valve is a first valve, wherein the apparatus further includes:
a hydraulic source coupled to the reservoir, the hydraulic source to receive the hydraulic fluid from the reservoir; and
a second valve coupled to the hydraulic source and the accumulator, the second valve to, when open, cause the hydraulic fluid in the hydraulic source to flow into the accumulator.

17. The apparatus of claim 16, wherein the controller is to output the control signal to a control coil, wherein the control signal being applied to the control coil causes the second valve to open.

18. The apparatus of claim 15, wherein the valve is a first valve and the fan pitch actuation system, the accumulator, and first valve is included in a first engine, wherein the apparatus further includes:
a second valve coupled to a hydraulic source included in a second engine and the accumulator, the second valve to, when open, cause the hydraulic fluid in the hydraulic source to flow into the accumulator.

19. An apparatus comprising:
interface circuitry to output a control signal to a valve to cause a blade of a propeller to automatically change from a first pitch angle to a second pitch angle;
machine readable instructions; and
at least one programmable circuit to at least one of execute or instantiate the machine readable instructions to at least:
determine at least one of a flight information, engine information, or pilot preferences; and
based on a triggering event, generate the control signal based on the at least one of the flight information, the engine information, or the pilot preferences.

20. The apparatus of claim 19, wherein the valve is a first valve, the control signal is a first control signal, and the first valve and the blade are included in a first engine, the at least one programmable circuit to:
determine whether an inflight shutdown is occurring; and
at least one of:
output a second control signal to cause a second valve to restore hydraulic fluid to an accumulator from a first hydraulic source of the first engine based on the inflight shutdown occurring; or
output a third control signal to cause a third valve to restore hydraulic fluid to the accumulator of the first engine from a second hydraulic source of a second engine based on the inflight shutdown not occurring.
